(19) United States
(12) Patent Application Publication
(10) Pub. No.: US 2007/0264878 A1
(43) Pub. Date: Nov. 15, 2007

(54) PROBE, TESTING HEAD HAVING A PLURALITY OF PROBES, AND CIRCUIT BOARD TESTER HAVING THE TESTING HEAD

(75) Inventors: Kosuke Hirobe, Kyoto (JP); Makoto Fujino, Kyoto (JP); Minoru Kato, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC-READ CORPORATION, Kyoto (JP)

(21) Appl. No.: 11/746,809

(22) Filed: May 10, 2007

(30) Foreign Application Priority Data
May 12, 2006 (JP) 2006-134202

(51) Int. Cl. H01R 13/24

(52) U.S. Cl. 439/700

(57) ABSTRACT

A probe and a testing head including the probe is used for inspecting electric characteristics of a wiring pattern of circuit board. The testing head includes a guiding member having a first guiding base having a first through hole, and a second guiding base arranged to face the first guiding base with a gap defined therebetween and having a second through hole aligned with the first through hole. The probe includes a first pin body having a measuring end arranged to be in contact with the circuit board, a measuring-end side of the first pin body is slidably supported in the first through hole of the first guiding base and the other-end side is slidably supported in the second through hole of the second guiding base. The probe also includes a second pin body arranged coaxial with the first pin body and supported in the second through hole. The second pin has one end directed to the other end of the first pin body and an external connection end to be connected to an electrode. A coil spring supported in the second through hole in a compressible manner, one end of the coil spring is electrically connected to the other end of the first pin body, and the other end of the coil spring is electrically connected to the one end of the second pin body.

### BACKGROUND OF THE INVENTION

1. Field of the Invention

The present invention generally relates to a probe used for testing electric characteristics of a circuit board, a testing head having a plurality of probes, and a circuit board tester having the testing head.

2. Description of the Related Art

Nowadays, improving the density of electrical components (e.g., semiconductor devices and resistors arranged on a circuit board) is demanded, and a fine-wiring pattern is one of the approaches to meet the demand. In general, prior to the installation of electric components, electrical characteristics of the circuit board having the fine wiring pattern are inspected by measuring resistance and/or voltage at a predetermined electric circuit of the wiring pattern. For example, electrical characteristics of the circuit board are inspected by measuring voltage between predetermined two lands of the electric circuit with two probes connected thereto, applying electrical current of the predetermined magnitude, and comparing the measured voltage with the predetermined reference voltage.

The laid open Japanese patent application No. 2001-41977 discloses a testing head, used for a circuit board tester having a plurality of probes 200 with tip ends abutted against lands L on a circuit board B, and a guiding member 202 supporting a plurality of probes 200 (see FIG. 8).

Each of the probes 200 includes a first pin body 204, a second pin body 206, and a coil spring 208 arranged between the first pin body 204 and the second pin body 206. The guiding member 202 includes a first guiding plate 210, a second guiding plate 212, and a first spacer 214 arranged between the first guiding plate 210 and the second guiding plate 212 to provide an interspace defined therebetween. The guiding member 202 also includes a third guiding plate 216 and the fourth guiding plate 218 supporting the second pin body 206, and a second spacer 220 arranged between the third guiding plate 216 and fourth guiding plate 216 to provide an interspace defined therebetween. In addition, a fifth guiding plate 222 and a sixth guiding plate 224 are provided between the second and the third guiding plate 212, 216 to support the coil spring 208.

Through the configuration described above, when the testing head is relatively pressed against the circuit board B, the coil spring 208 is compressed and a tip end of the first pin body 204 is elastically pressed against the land L on the circuit board B.

As described above, the testing head is constituted with three sets of the guiding plates, the first guiding plate 210 and the second guiding plate 212 supporting the first pin body 200, the third guiding plate 216 and the fourth guiding plate 218 supporting the second pin body 206, and the fifth guiding plate 222 and the sixth guiding plate 224 supporting the coil spring 208. Thus, the structure of the testing head is complex, and assembling the testing head, as well as the circuit board tester having the testing head, is difficult, time consuming and labor-intensive. In addition, since the structure of the testing head is complex, replacing the probes 200 becomes laborious when they are worn.

### SUMMARY OF THE INVENTION

In order to overcome the problems described above, preferred embodiments of the present invention provide a probe that facilitates the assembly of a testing head, the testing head having a plurality of probes, and a circuit board tester having the testing head.

According to preferred embodiments of the present invention, a probe having electric conductivity and used for inspecting electrical characteristics of a circuit board is provided. The probe is supported on a guiding member including a first guiding base and a second guiding base, arranged with a space defined therebetween.

The probe includes a first pin body having a measuring end arranged to be in contact with the circuit board, a measuring-end side of the first pin body is slidably supported in a first through hole formed in the first guiding base and the other-end side is slidably supported in a second through hole formed in a second guiding base that is coaxial with the first through hole.

The probe also includes a second pin body arranged coaxially with the first pin body and supported in the second through hole. The second pin has one end directed to the other end of the first pin body and an external connection to be connected to an electrode end.

The probe further includes a coil spring supported in the second through hole. One end of the coil spring is electrically connected to the other end of the first pin body, and the other end of the coil spring is electrically connected to the one end of the second pin body.

According to a preferred embodiment of the present invention, a testing head used for inspecting electrical characteristics of the wiring pattern of circuit board includes a guiding member defined with a first guiding base made of insulating material and having a first through hole, and a second guiding base arranged to face the first guiding base with a gap defined therebetween and having a second through hole aligned with the first through hole.

The testing head further includes a plurality of probes arranged on the guiding member. Each of the probes includes a first pin body having a measuring end arranged to be in contact with the circuit board, a second pin body arranged coaxial with the first pin body and supported in the second through hole, and a coil spring supported in the second through hole in a compressible manner.

The measuring-end side of the first pin body is slidably supported in the first through hole of the first guiding base and the other-end side is slidably supported in the second through hole of the second guiding base. The second pin has one end directed to the other end of the first pin body and an external connection end to be connected to an electrode. One end of the coil spring is electrically connected to the other end of the first pin body, and the other end of the coil spring is electrically connected to the one end of the second pin body.

Other features, elements, steps, processes, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an internal configuration of a circuit board tester having a testing head according to a first preferred embodiment of the present invention.

FIG. 2 is a plan view of the circuit board tester illustrated in FIG. 1.

FIG. 3 is a block diagram of an electric configuration of the circuit board tester illustrated in FIG. 1.

FIG. 4 is a block diagram illustrating an electric configuration of a scanning unit illustrated in FIG. 3.

FIG. 5 schematically illustrates the testing head installed to the circuit board tester illustrated in FIG. 1.

FIG. 6 is a cross sectional view of a principal portion of the testing head illustrated in FIG. 5.

FIG. 7 is a front view of a probe constituting the testing head illustrated in FIG. 6.

FIG. 8 is a cross sectional view of a conventional testing head.

### DETAILED DESCRIPTION OF THE PREFERRED EMBODIMENTS

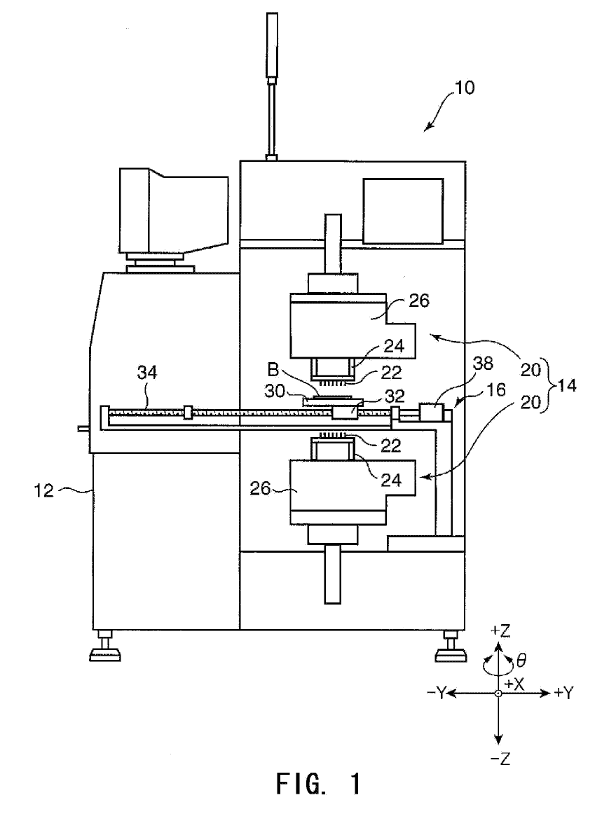

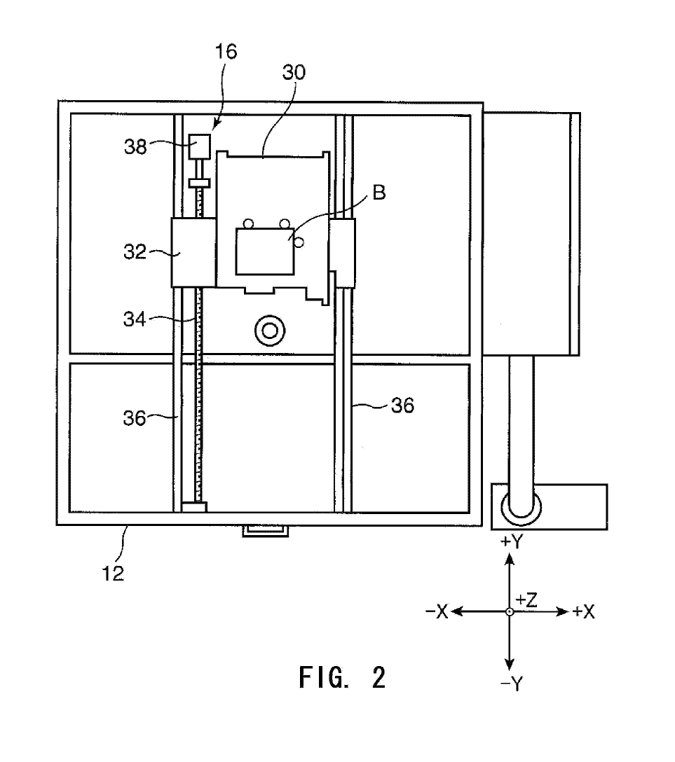

In a following description of preferred embodiments of the present invention, a term “circuit board” intends to mean that it includes a printed circuit board, a flexible circuit board, a multilayer circuit board, an electrode plate used for display devices (e.g., a liquid crystal display device and a plasma display devices), a package type circuit board used for a package integrated circuit, a semiconductor wafer, and a film carrier. FIG. 1 is a drawing illustrating an internal configuration of a circuit board tester 10 having a testing head 24 in which a plurality of probes 22 according to a first preferred embodiment of the present invention are arranged. FIG. 2 is a plan view of the circuit board tester 10 illustrated in FIG. 1. In FIGS. 1 and 2, axis of coordinate is illustrated to describe positional relationships of components of the circuit board tester 10.

The circuit board tester 10 having the testing head 24 according to a preferred embodiment of the present invention includes a case 12, a testing member 14 which inspects a circuit board B, and a conveyer 16 which moves the circuit board B. As illustrated in FIG. 1, the testing member 14 is arranged in the casing 12, at substantially the middle of a front side (i.e., −Y side) and a back side (i.e., +Y side) of the casing 12. The conveyer 16 is arranged between the front side and the back side of the casing 12. The conveyer 16 moves the untested circuit board B from the front side of the casing 12 toward the back side to feed the circuit board B to the testing member 14, and then the tested circuit B board is moved to the back side of the casing 12.

The testing member 14 preferably includes two testing units 20, one is arranged upward (+Z side) of the circuit board B and inspects the wiring pattern on an upper side of the circuit board B, and another is arranged downward (−Z side) of the circuit board B and inspects the wiring pattern on a lower side of the circuit board B. Each of the testing units 20 includes the testing head 24 and a head shifting mechanism 26. The testing head 24 includes a plurality of probes 22 (e.g., about two hundreds probes 22) to be in contact with lands of an electric circuit of the wiring pattern on the circuit board B. The head shifting mechanism 26 moves the testing head 24 in directions along a Y axis (i.e., a Y direction) and/or along a Z axis (i.e., a Z direction).

The conveyer 16 includes a carrying table 30 on which the circuit board B is placed, a ball screw 34 to which a nut portion 32 of the carrying table 30 is fitted for moving the carrying table 30 in the Y direction by rolling the ball screw 34, a pair of guiding rails 36 which support the carrying table 30 such that the carrying table 30 moves in the Y direction in accordance with a rotation of the ball screw 34 in a stable manner, and a motor 38 which drives the ball screw 34 and is controlled by a later-described control unit 40. The carrying table 30 includes an opening enabling the testing head 24 arranged downward of the circuit bard B to access the wiring pattern on the lower side of the circuit board B through the opening.

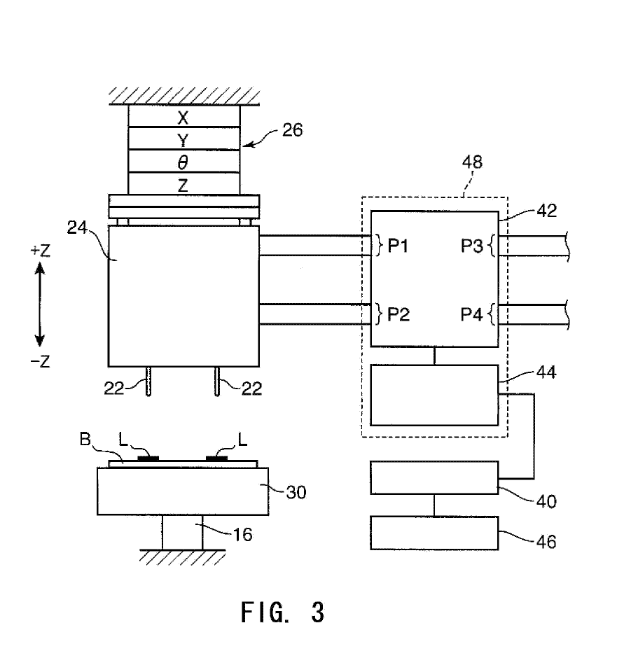

FIG. 3 is a block diagram illustrating an electric configuration of the circuit board tester 10. As illustrated in FIG. 3, the circuit board tester 10 includes the control unit 40, a scanning unit 42, a tester controlling unit 44, and an operation panel 46. The control unit 40 includes a micro computer with a CPU, a ROM, and a RAM for example, and controls an operation of the circuit board tester 10 in accordance with a program stored on the ROM. The scanning unit 42 scans the probes 22 being in contact with the lands L of the electric circuit of the wiring pattern provided on the circuit board B. More particularly, the scanning unit 42 sequentially selects a set of probes 22 connected to the lands L arranged at both ends of the electric circuit of wiring pattern to be inspected, and then sends an inspection-signal thereto. Upon receiving the scanning-instruction from the control unit 40, the tester controlling unit 44 sends the scanning-command to the scanning unit 42. The operation panel 46 has, for example, an input part for entering an instruction of the operator and a display portion for displaying the inspection result of the wiring pattern. With the scanning unit 42 and the tester controlling unit 44, a circuit testing portion 48 executing the inspection of electric characteristics of the circuit board B is defined.

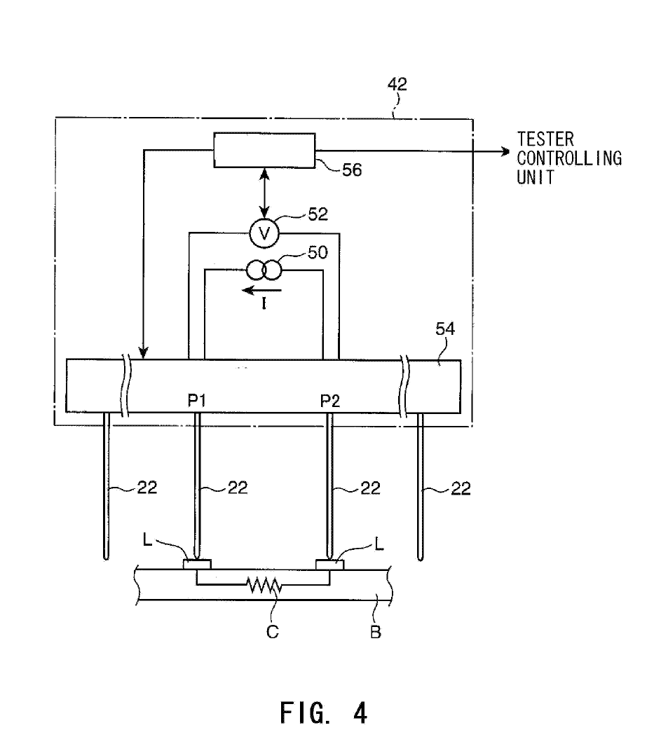

FIG. 4 is a block diagram illustrating an electric configuration of the scanning unit 42. As illustrated in FIG. 4, the scanning unit 42 includes a current source 50, a voltage gauge 52, a selector switch 54, and a processor 56. The current source 50 applies the electric current at a predetermined magnitude to an area between two lands L arranged at both ends of an electric circuit C. The voltage gauge 52 measures the magnitude of the voltage generated between the lands L when the electric current at the predetermined magnitude is applied to the electric circuit C. The selector switch 54 (e.g., a switch array) connects the current source 50 and the voltage gauge 52 between a set of the probes 22 selected from among a plurality of probes 22 arranged on the testing head 24. The processor 56 sends a switching-control signal to the selector switch 54. In addition, the processor 56 compares the magnitude of the voltage measured by the voltage gauge 52 with a reference voltage. Based on the comparison, the processor 56 determines the quality of the inspected circuit board B (i.e., the continuity of the electric circuit C) and transmits its judgment to the tester controlling unit 44.

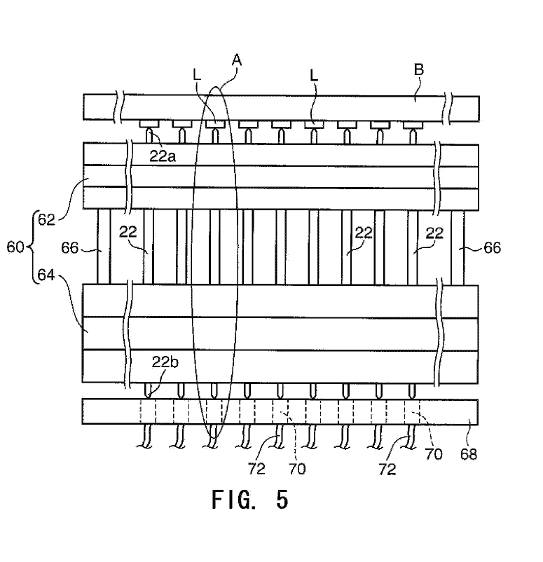

FIG. 5 is a drawing schematically illustrating the testing head 24 including a magnification of a principle portion of the testing head 24. In the present preferred embodiment of the present invention, the testing unit 20 includes a pair of the testing heads 24, one is to be arranged above the circuit board B and the other is to below of the circuit board B. However, the configuration of two testing heads 24 are similar to each other, and thus, in the following description configurations of the testing head 24 arranged below the circuit board B will be described in detail.

The testing head 24 includes a guiding member 60 made of an insulating material (e.g., synthetic resin) and a plurality of needle-shape probes 22 supported by the guiding member 60. Each of the probes 22 is made of a conductive material such that the probes 22 have a conductivity that is necessary for inspecting the electric characteristics of the wiring pattern on the circuit board B. The probes 22 are arrayed on the guiding member 60 such that the arrangement thereof corresponds to those of the lands L of the wiring pattern arranged on the circuit board B to be inspected.

The guiding member 60 includes a first guiding base 62, a second guiding base 64, and a plurality of guiding posts 66. The guiding posts 66 are arranged between the first guiding base 62 and the second guiding base 64 such that the first guiding base 62 and the second guiding base 64 face each other with a space defined therebetween.

Each of the probes 22 includes a measuring end 22a protruding from the first guiding member 62 toward the circuit board B such that the measuring end 22a is in contact with the land L on the circuit board B in an elastic manner (or a crimping manner). The other end of each of the probes 22 is an external connection end 22b protruding from the second guiding member 64 toward the electrode plate 68 such that the external connection end 22b is in contact with each of electrodes 70 in an elastic manner (or a crimping manner). A plurality of electrodes 70 are arrayed on the electrode plate 68 such that each of electrodes 70 corresponds to each of the probes 22. Wires 72, each of which corresponds to each of probes 22, are respectively connected to the electrodes 70 to provide the electric current in the predetermined magnitude to a set of the lands L. Through the configuration, electric current is applied to the set of the lands L and the voltage between the lands L is measured.

Next, the operation of the circuit board tester 10 according to the preferred embodiment of the present invention will be described with reference to FIGS. 3 to 5. Firstly, the conveyer 16 and the head shifting mechanism 26 are controlled such that the circuit board B placed on the carrying table 30 is carried and the measuring end 22a of each of probes 22 is brought in contact with corresponding land L of the wiring pattern arranged on the circuit board B. Secondly, a set of probes 22, in contact with both ends of a certain wiring pattern to be inspected, are selected from among a plurality of probes 22 being in contact with the lands L of the circuit board, in accordance with the scanning instruction from the tester controlling unit 44.

For example, as illustrated in FIG. 4, a port P1 of the selector switch 54 connected, by one of the wires 72, to one of probes 22 being in contact with one of the lands L arranged on one end of the electric circuit C, and a port P2 of the selector switch 54 connected, by the other of wires 72, to the other of probes 22 being in contact with the other of lands L arranged on the other end of the electric circuit C are selected. As described above, the current source 50 and the voltage gauge 52 are connected between a predetermined set of the probes 22 connected to the port P1 and the port P2 respectively.

Thirdly, the current source 50 applies an electric current I to the electric circuit C through the port P1 and the port P2, and the voltage gauge 50 measures the voltage V of the electric circuit C. The voltage V may be calculated by multiplying the electric current I and a resistance R of the electric circuit C. Then, the processor 56 compares the voltage V with the reference voltage Vf. When the voltage V exceeds the reference voltage Vf, the processor 56 recognizes the electric circuit C is in a defective condition (i.e., a conductive material of the pattern is peeled). When the voltage V is equal or less than the reference voltage Vf, the processor 56 recognizes the electric circuit C is in a favorable condition. The test result is then sent to the tester controlling unit 44.

When the electric circuit C is recognized as being in a favorable condition, the other set of the probes 22 in contact with both ends of the other electric circuit C are selected in accordance with the scanning instruction from the tester controlling unit 44, and the other circuit pattern C is inspected in the same manner as described above. When the electric circuit C is recognized as being in the defective condition, the tester controlling unit 44 sends to the control unit 44 an error-signal indicating the inspected circuit board B is defective. Then, an error massage is displayed on the operation panel 46, and the further inspection of the circuit board B is terminated.

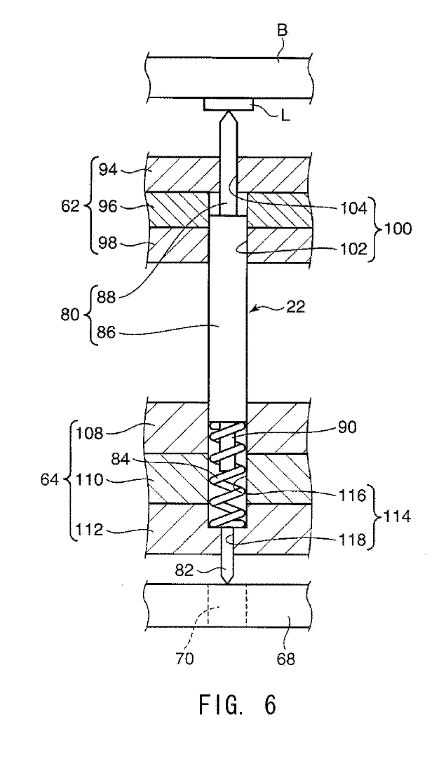

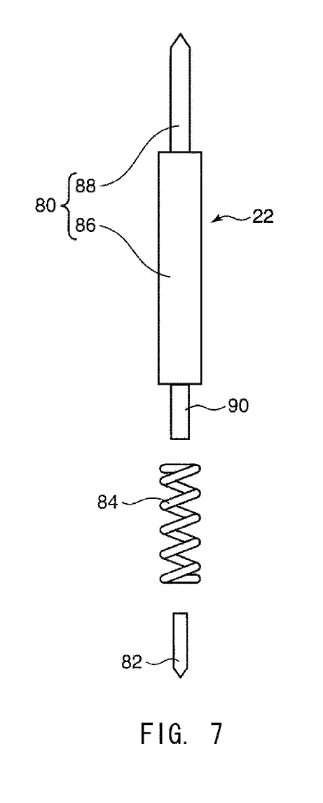

With reference to FIGS. 6 and 7, a detail configuration of the testing head 24 illustrated in FIG. 5 will be described in detail. FIG. 6 is a cross-sectional view of a principle portion of the testing head 24, marked with an ellipse A in FIG. 5. FIG. 7 is an exploded view of one of the probes 22. As illustrated in FIGS. 6 and 7, each of the probes 22 includes a first pin body 80, a second pin body 82, and a coil spring 84 arranged therebetween. The first pin body 80 includes the measuring end 22a to be in contact with the circuit board B on one end thereof, and a second pin body 82, arranged coaxially with the first pin body 80 such that one end thereof is directed to the other end of the first pin body 80, includes on the other side thereof the external connection end 22b to be connected to the corresponding electrode 70. The coil spring 84 is arranged between the other end of the first pin body 80 and the one end of the second pin body 82. The first pin body 80 and the second pin body 82 are made of a metallic material (e.g., a tungsten material and a beryllium copper material) so as to have favorable flexibility. The coil spring 84 is made of a metallic material suitable for forming a spring (e.g., music wires).

The first pin body 80 includes a wide section 86, a narrow section 88, and a spring-fit portion 90. The narrow section 88 includes the measuring end 22a having a sharpened shape on its one end, and the other end is integrally connected to one end of the wide section 86. The wide section 86 has on the other end a diameter wider than the outer diameter of the coil spring 84. The spring-fit portion 90 protrudes from the other end of the wide section 86 and has a diameter substantially the same as the inner diameter of the compressed spring coil 84 such that the spring-fit portion 90 is fitted into the coil spring 84.

The second pin body 82 has a length that is shorter in the length direction than that of the first pin body 80 and a diameter smaller than that of the wide section 86 of the first pin body 80. One end of the second pin body 82 is integrally connected (e.g., welded) to the coil spring 84.

As described above, the narrow section 88 of the first pin body 80, having the measuring end 22a on one side thereof, has a smaller diameter than the wide section 86, thus, a wider clearance is maintained between the measuring ends 22a of neighboring probes 22. Through this unique configuration, the adhesion of the contaminations (e.g., dust, dirt, debris, etc.) is prevented. In addition, the probes 22 may be arrayed in a denser manner on the testing head 24, enabling of inspection of a circuit board having an improved circuit density.

Through the configuration described above, in which the spring-fit portion 90 of the first pin body 80 is fitted into the coil spring 84, the positional relationship between the first pin body 80 and the coil spring 84 (e.g., alignment therebetween) is preferably maintained, and electric conductivity between the first pin body and the coil spring 84 is preferably maintained, enabling the testing head 24 to operate in a reliable manner.

Meanwhile, as described, the second pin body 82 has the smaller diameter than the wide section 86 of the first pin body 80, thus, a wider clearance is maintained between the external connection ends 22b of neighboring probes 22, enabling to maintain the preferable insulating characteristics of the neighboring probes 22 of the testing head 24. In addition, by making the second pin body 82 shorter and smaller than the first pin body, an overall size of the probe 22 is reduced, leading to reduction in size of the testing head 24.

A first guiding base 62 of the guiding member 60 is formed by laminating a first guiding plate 94, a second guiding plate 96, and the third guiding plate 98. The first guiding plate 94 is arranged so as to face the circuit board B, and the second guiding plate 96 is sandwiched between the first guiding plate 94 and the third guiding plate 98. The third guiding plate 98 is arranged so as to face the second guiding base 64. The first guiding base 62 has a first through hole 100, and the first pin body 80 is slidably supported therein while the measuring end 22a protrudes therefrom toward the circuit board B.

The first through hole 100 is defined with two sections, a first wide hole section 102 and a first narrow hole section 104 aligned to each other. In the first wide hole section 102, a portion of the wide section 86 of the first pin body 80 is supported in a slidable manner. The first narrow hole section 104 has a diameter smaller than that of the first wide hole section 102, and a portion of the narrow section 88 of the first pin body 80 is supported therein in a slidable manner. The first wide hole section 102 is formed in the second guiding plate 96 and the third guiding plate 98, and the first narrow hole section 104 is formed in the first guiding plate 94. The first guiding base 62 having the first through hole 100 is formed by laminating and securing (e.g., with the screws) the first to third guiding plates 94, 96, and 98, in each of which the holes corresponding to the first wide hole section 102 and the first narrow hole section 104 are formed beforehand. As described above, the first through hole 100 having the first wide hole section 102 and the first narrow hole section 104, different in the diameter from each other, may be easily provided to the first guiding base 62 by laminating and securing the first to third guiding plates 94, 96, and 98.

Through the configuration described above, a movement of the first pin body 80 is restricted by engaging one end of the wide section 80 with the first guiding plate 94 around the first narrow hole section 104, preventing the first pin body 80 from coming off toward the circuit board B. In the description of preferred embodiments of the present invention, “slidable” means that the first pin body 80 is smoothly movable in the first through hole 100. The pin body 80 is slibadly supported in the first through hole 100 by configuring the inner diameter of the first through hole 100 slightly larger than the diameter of the first pin body 80.

Similar to the first guiding base 62, the second guiding base 64 of the guiding member 60 is formed by laminating a fourth guiding plate 108, a fifth guiding plate 110, and the sixth guiding plate 112. The fourth guiding plate 108 is arranged so as to face the first guiding base 62, and the fifth guiding plate 110 is sandwiched between the fourth guiding plate 108 and the sixth guiding plate 112. The sixth guiding plate 112 is arranged so as to face the electrode plate 68. The second guiding base 64 has a second through hole 114 in which a portion of the wide section 86 of the first pin body 80 is slidably supported, the coil spring 84 is loosely fitted, and the second guiding base 64 is supported while the external connection end 22b protrudes from the second guiding base 64 toward the electrode plate 68.

The second through hole 114 is defined with two sections, a second wide hole section 116 and a second narrow hole section 118 aligned to each other. In the present preferred embodiment of the present invention, a portion of the wide section 86 of the first pin body 80 is slidably supported in the second wide hole section 116. In addition, the coil spring 84, in which the spring-fit portion 90 is fitted, are loosely fitted in the second wide hole section 116. The second narrow hole section 118 has a diameter smaller than that of the second wide hole section 116, and a portion of the second pin body 82 is supported therein in a slidable manner. The second wide hole section 116 is formed in the third guiding plate 108, the fourth guiding plate 110, and a portion of the fifth guiding plate 112. The second narrow hole section 118 is formed in the first guiding plate 94 continuously extending from the second wide hole section 116. The second guiding base 64 having the second through hole 114 is formed by laminating and securing (e.g., with the screws) the fourth to sixth guiding plates 94, 96, and 98, in which the through holes corresponding to the first wide hole section 102 (the sixth guiding plate 98 also includes the hole corresponding to the first narrow hole section 104 as well) are formed beforehand. In the present preferred embodiment of the present invention, the second pin body 82 is loosely fitted into the second narrow hole section 118. As described above, the second through hole 114 defined with the second wide hole section 116 and the second narrow hole section 118 may be easily provided to the second guiding base 64 by laminating and securing the fourth to sixth guiding plates 108, 110, and 112.

In the present preferred embodiment of the present invention, the diameter of the second wide hole section 116 is configured to be slightly greater than the outer diameter of the coil spring 84, such that the coil spring 84 is freely compressed and expanded within the second wide hole section 116 of the second through hole 114. In addition, the first pin body 80 is slidably supported in the second through hole 114 by configuring the inner diameter of the second through hole 114 slightly larger than the diameter of the first pin body 80. Meanwhile, in the description of preferred embodiments of the present invention, “slidable” means that the first pin body 80 is smoothly movable in the second through hole 114. Through the configuration described above, in which the first pin body 80 is supported in the through holes 100 and 114, the first pin body 80 is supported without being jounced.

Moreover, the second pin body 82, whose one end is welded to the coil spring 84, has a diameter smaller than that of the compression coil spring 84. The coil spring 84 engages with the sixth guiding plate 112 at a portion where the second narrow hole section 118 extends, preventing the second pin body 82 from being removed toward the electrode 70.

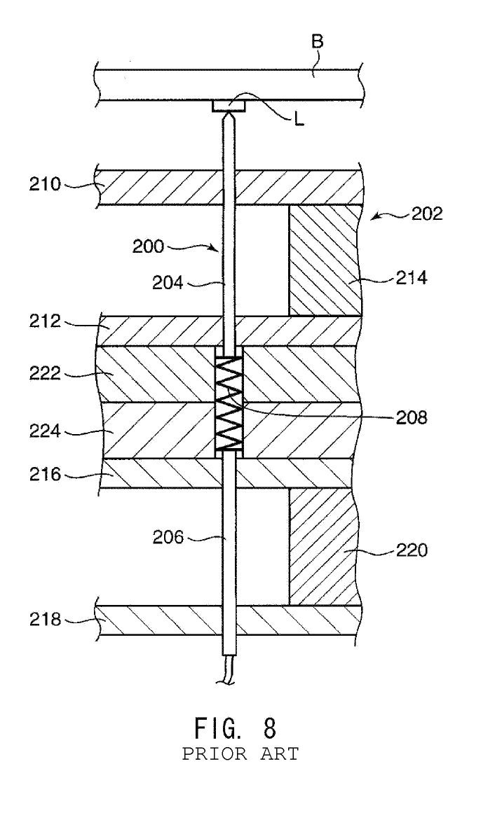

As described above, a first portion of the wide section 86 of the first pin body 80, a circuit-board-side portion thereof, is slidably supported in the first through hole 100, a second portion of the wide section 86 of the first pin body 80, an electrode-plate-side portion thereof, is slidably supported in the second through hole 114, and a third portion of the wide section 86 of the first pin body arranged between first and second portions are disposed between the first guiding base 62 and the second guiding base 64. In addition, the second wide hole section 116 of the second guiding base 64 is configured so as to support the coil spring 84 in a freely compressible and expandable manner and support a portion of the first pin body 80 in a slidable manner. Thus, unlike the conventional art illustrated in FIG. 8, it is not necessary to provide a member supporting end portions of the first pin body 80 and second pin body 82 to the testing head 24 according to the present preferred embodiment of the present invention, enabling to simply the configuration of the testing head 24.

When the testing head 24 is moved toward the circuit board B placed on the carrying table 30 by activating the head shifting mechanism 26, the measuring end 22a of each first pin body 80 is abutted against the corresponding land L respectively. When the testing head 24 is further pressed against the circuit board B, the first pin body 80 is pressed toward the second guide base 64, causing the coil spring 84 to be compressed. Thus, the measuring end 22a of the first pin body 80 is in contact with the corresponding land L in an elastic manner, enabling a decrease in the contact resistance and improvement of the operational reliability of the testing head 24.

According to a preferred embodiment of the present invention, the guiding member 60 of the testing head 24 has a simple structure, defined by the first guiding base 62 and the second guiding base 64, compared with the related art having three guiding bases and illustrated in FIG. 8. Thus, the preferred embodiments of the present invention facilitate manufacturing of the testing head 24 and the circuit board tester 10. Moreover, the simple structure of the guiding member 60 facilitates the replacement of the worn probes 22. Since the guiding member 60 is defined with the first guiding base 62 and the second guiding base 64, the probes 22 may be removed from the testing head 24 by detaching the first guiding base 62 and the second guiding base 64.

In preferred embodiments of the present invention, the first pin body 80 is made of the metallic material and has a favorable flexibility. Through the configuration, the first pin body 80 is elastically bent at the space defined between the first guiding base 62 and the second guiding base 64 after the coil spring 84 is compressed, enabling to further reduce the contact resistance and improve the operational reliability of the testing head 24.

While preferred embodiments of the present invention have been described above, it is to be understood that variations and modifications will be apparent to those skilled in the art without departing the scope and spirit of the present invention.

In the foregoing preferred embodiments of the present invention, each of the first guiding base 62 and the second guiding base 64 is preferably formed by laminating three guiding plates. It should be noted, however, the configuration of the guiding base is not limited to the foregoing preferred embodiments. For example, each guiding base may be formed by laminating two guiding plates, or four or more of guiding plates. Alternatively, the guiding base may be constituted with a single guiding plate, as long as machining accuracy of the through holes 100 and 114 is maintained.

In the foregoing preferred embodiments, the first pin body 80 includes a wide section 86 and the narrow section 88. Alternatively, the first pin body 80 may have the same diameter across the entire section thereof. In this case, the first through hole 100 is configured to have a diameter substantially the same as that of the first pin body 80, and due to the friction generated around an outer circumferential surface of the first pin body 80, itis prevented that the first pin body 80 comes off toward the circuit board B.

In the foregoing preferred embodiments of the present invention, the first pin body 80 preferably has a wide section 86 having a greater diameter than the outer diameter of the coil spring 84. Alternatively, the diameter of the wide section 86 may have a diameter that is substantially the same as the outer diameter of the compressed spring coil 84. In this case, the end portion of the first pin body 80 may be slidably inserted into the second wide hole section 116 of the second guiding base 64, thus a simple structure of the testing head 24 is preferably maintained.

In the foregoing preferred embodiments of the present invention, the spring-fit portion 90 protrudes from the other end of the wide section 86 and has a diameter that is substantially the same as the inner diameter of the coil spring 84 such that the spring-fit portion 90 is fitted into the coil spring 84. Alternatively, the spring-fit portion 90 may have a diameter that is smaller than the inner diameter of the coil spring 84. In this case, the spring-fit portion 90 is loosely fitted into the compressed coil 84. However, the conductivity of the first pin body and the coil spring is preferably maintained by contacting the end portions of the wide section 86 and the first pin body 80. Alternatively, the spring-fit portion 90 may not be provided to the first pin body 80. In this case as well, the conductivity of the first pin body and the coil spring are preferably maintained by contacting the end portions of the wide section 86 and the first pin body 80.

In the foregoing preferred embodiments of the present invention, the second pin body 82 has the diameter smaller than that of the wide section 86 of the first pin body 80. Alternatively, the second pin body 82 may have a diameter substantially the same as that of the wide section 86 of the first pin body 80.

In the foregoing preferred embodiments of the present invention, the second pin body 82 is fixed to the coil spring 84 by welding. Alternatively, the second pin body 82 may not be fixed to the coil spring 84. In this case, the second pin body 82 and the coil spring 84 are electrically connected each other by contacting their end portions.

In the foregoing preferred embodiments of the present invention, the wiring pattern of the circuit board B are inspected preferably by comparing the voltage V measured by the voltage gauge 52 with the reference voltage Vf. Alternatively, the wiring pattern of the circuit board B may be inspected by comparing the resistance R of the wiring pattern with the reference resistance Rf. The resistance R of the wiring pattern may be calculated from the voltage V measured by the voltage gauge 52 by carrying out calculation of the formula “R=V/I”.

In the foregoing preferred embodiments of the present invention, the electric characteristics of the wiring pattern are determined based on the voltage V obtained from the voltage gauge 52. The voltage V is measured by applying the electric current of the predetermined magnitude to each of the wiring pattern with use of the probes 22 contacted to both ends of the selected wiring pattern. Alternatively, the electric characteristics of the wiring pattern may be determined based on the current magnitude I, measured by applying the voltage of the predetermined magnitude to the wiring pattern with use of the probes 22 contacted to both ends of the selected wiring pattern.

In the foregoing preferred embodiments of the present invention, the first pin body 80 constituting the probe 22 is preferably made of a metallic material and has a favorable flexibility. Alternatively, the first pin body 80 may be made of resin material having a sufficient hardness (e.g., fluoroethylene resin, silicon resin and the like). In this case, a conductive layer is formed on the resin first pin body 80 by the electroless deposition, the sputtering, and the like to maintain the preferable conductivity of the probe 22.

In the foregoing preferred embodiments of the present invention, external connection ends 22b of a set of the selected probes 22 are electrically connected to the current source 50 and the voltage gauge 52 with the coaxial cable. Alternatively, a single wire or a twisted wire may be used for connecting the voltage gauge 52 and the current source 50 to the external connection ends 22b.

In the foregoing preferred embodiments of the present invention, the circuit board tester 10 includes the two testing units 20, one is arranged upward of the circuit board B, the other is arranged downward of the circuit board B, and each of testing units 20 includes a testing head 24. Alternatively, the testing head 20 may be arranged on either one of upward or downward of the circuit board B. In this case, one side of the circuit board B is firstly inspected, and then, the circuit board B is flipped over and the other side of the circuit board B is inspected.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A testing head used for inspecting electrical characteristics of a wiring pattern of a circuit board, the testing head comprising:
a first guiding base made of insulating material and having a first through hole;
a second guiding base facing the first guiding base with a gap defined therebetween and having a second through hole that is substantially aligned with the first through hole;
a first pin body having a measuring end arranged to be moved into contact with the circuit board, a measuring-end side of the first pin body is slidably supported in the first through hole of the first guiding base and the other-end side is slidably supported in the second through hole of the second guiding base;
a second pin body arranged substantially coaxial with the first pin body and supported in the second through hole, the second pin body has one end directed to the other end of the first pin body and an external connection end to be connected to an electrode; and
a coil spring supported in the second through hole in a compressible manner, the coil spring is compressed by being pressed with the other end of the first pin body and the one end of the second pin body when the probe is pressed against the circuit board.

2. The testing head as set forth in claim 1, wherein a portion of the first pin body is fitted within the coil spring.

3. The testing head as set forth in claim 1, wherein the first pin body includes:
a wide section having a diameter that is substantially equal to or greater than that of the coil spring;
a narrow section having the measuring end on one side thereof and the other side integrally connected to one side of the wide section, a diameter of the narrow section is smaller than a diameter of the wide section;
a spring-fit portion extending from the other side of the wide section and fitted in the coil spring, the spring fit portion has a diameter that is substantially equal to an inner diameter of the spring coil but smaller than the diameter of the wide section.

4. The testing head as set forth in claim 3, wherein first and second portions of the wide section extend into the first and second through holes, respectively, and a third portion of the wide section is disposed between the first and second guiding bases.

5. The testing head as set forth in claim 3, wherein the first through hole includes:
a first wide hole section having a diameter that is substantially equal to or slightly greater than the diameter of the wide section of the first pin body; and
a first narrow hole section continuously extending from the first wide hole section in a manner that is substantially coaxial with the first wide hole section and having a diameter substantially equal to or slightly greater than the diameter of the narrow section of the first pin body; and
the narrow section of the first pin body is inserted into the first narrow hole section of the first through hole and the wide section of the first pin body is inserted into the first wide hole section of the first through hole.

6. The testing head as set forth in claim 1, wherein the second pin body has a length in a longitudinal direction and a diameter smaller than those of the wide section of the first pin body, and has one end fixed to the other end of the coil spring.

7. The testing head as set forth in claim 6, wherein the second through hole includes:
a second wide hole section having a diameter substantially equal to or slightly greater than the outer diameter of coil spring; and
a second narrow hole section continuously extending from the second wide hole section in a manner substantially aligned with the wide hole section and having a diameter substantially equal to or slightly greater than the diameter of the second pin body; and
the coil spring is arranged in the wide hole section of the second through hole, and the second pin body is inserted into the wide hole section of the second through hole.

8. A probe used for the testing head as set forth in claim 1, wherein the probe is defined by the first pin body, the second pin body, and the coil spring.

9. The testing head as set forth in claim 1, wherein the first guiding base and the second guiding base define a guiding member, and the first pin body, the second pin body, and the coil spring defines a probe, a plurality of probes are arranged in the guiding member such that the testing head sequentially inspects the wiring pattern on the circuit board.

10. The testing head as set forth in claim 1, wherein each of the first guiding base and the second guiding base includes at least two insulting guiding plates.

11. The testing head as set forth in claim 3, wherein only a portion of the wide section is disposed between the first and second guiding bases.

12. A circuit board tester for inspecting a wiring pattern on a circuit board based on electrical characteristics of the electric circuit, the circuit board tester comprising:
the testing head as set forth in claim 9 arranged to measure electrical characteristics of the wiring pattern between predetermined points of the wiring pattern;
a power supply to be electrically connected to the external connection ends of the probes arranged in the testing head; and
a processor examining the wiring pattern based on the electric characteristics measured with the testing head.

13. A probe having electrical conductivity and used for inspecting electrical characteristics of a circuit board, the probe being supportable on a guiding member including a first guiding base and a second guiding base, arranged with a gap defined therebetween, the probe comprising:
a first pin body having a measuring end arranged to be moved into contact with the circuit board;
a second pin body arranged substantially coaxially with the first pin body, and having one end directed to the other end of the first pin body and an external connection end to be connected to an electrode; and
a coil spring arranged between the other end of the first pin body and the one end of the second pin body; wherein
the coil spring is compressed by being pressed with the other end of the first pin body and the one end of the second pin body when the probe is pressed against the circuit board.

14. The probe as set forth in claim 13, wherein the first pin body includes:
a wide section having a diameter that is substantially equal to or greater than a diameter of the coil spring;
a narrow section having the measuring end on one side thereof and the other side integrally connected to one side of the wide section, a diameter of the narrow section is smaller than the diameter of the wise section;
a spring-fit portion fitted into the coil spring, extending from the other side of the wide section, and having a diameter that is substantially equal to an inner diameter of the spring coil.

15. The probe as set forth in claim 13, wherein the second pin body has a length and a diameter that are less than those of the wide section of the first pin body, and has one end fixed to the other end of the coil spring.

16. The testing head as set forth in claim 13, wherein a portion of the first pin body is fitted within the coil spring.
